(19) United States
(12) Patent Application Publication
(10) Pub. No.: US 2005/0149362 A1
(43) Pub. Date: Jul. 7, 2005

(54) System and method for visually presenting digital patient information for future drug use resulting from dosage alteration

(76) Inventors: Per A. Peterson, Basking Ridge, NJ (US); Scott D. Myers, Skillman, NJ (US); Angela Shen-Hsieh, Cambridge, MA (US); Mark B. Schindler, Cambridge, MA (US); Jacqueline Alligood, Flemington, NJ (US)

Correspondence Address: Greenberg Traurig, LLP, 885 Third Avenue, New York, NY, 10022, US

(21) Appl. No.: 10/748,081

(22) Filed: Dec. 30, 2003

(51) Int. Cl. G06F 17/60

(52) U.S. Cl. 705/3

(57) ABSTRACT

This invention provides a system and method of visually presenting future drug use in a subject where the subject's usage of a drug is altered. The invention comprises selecting a drug associated with Digital Patient Information (DPI). Risk periods associated with the future drug usage period are also displayed.

### FIELD OF THE INVENTION

The present invention relates to a system and method for visually presenting future drug usage. In particular, the system and method of the present invention maintains a database of Digital Patient Information which includes drug information. The database includes the drug name, dosage, and administration time or frequency of administration. In addition, the database contains specific cautionary warnings and notices regarding the administration of the drug. A linear calendar indicating future drug usage and risk information is visually presented to the user of the invention based upon the Digital Patient Information and calendar dates and times entered by the user.

### BACKGROUND OF THE INVENTION

Drug information, including dosage and administration instructions, as well as risk information, are typically printed on medication bottles. However, there are many drugs, which often require complex dosage schedules having administration levels, routines and instructions that may change each specific time the drug is administered. Although many physicians will provide the patient with a written dosage schedule, patient's frequently forget to use their medications as prescribed, or confuse the frequency with which their medications are to be used.

The elderly, visually impaired, handicapped, and those who have not been exposed to higher education are especially prone to problems associated with improper self-administration of drugs. In most instances the patient's handicap or infirmity make it challenging to follow their doctor's instructions for taking the medication. The consequence of not properly taking the medication can be exacerbated by the fact that the patients are often taking multiple prescription medications, which can interact adversely when not properly taken. In addition, the level of physical infirmity in many patients reduces their ability to withstand the effects of improperly taking the medication. See U.S. Pat. No. 5,088,056 issued to McIntosh et al. for a detailed description of drug interaction problems associated with the self-administration of prescription medication. Furthermore, proper usage of a drug is subject to interruption or alteration based upon a number of discrete circumstances, and alteration of a drug use schedule may indeed be desirable by a user. Determining future drug use resulting from an alteration in a subject's drug usage is complicated and, if done improperly, can present grave risks to a subject.

Very often a person desires to begin a drug usage regimen, is unable to comply with a drug usage regimen, or desires to change the timing of a drug taking regimen. In these instances a person will want to alter their drug usage regimen without losing the beneficial effect of taking the drug or otherwise incurring a risk by virtue of the altered usage. Also, in the event of altered drug usage, for example a late or missed drug administration, a drug user desires to be made aware of the risks thereby incurred and, if possible, how to mitigate or negate these risks.

An example of the difficulties that exist in the current state of the art are illustrated by use of the Ortho Evra™ contraceptive patch. The four week cycle of use for the contraceptive patch entails a weekly “Patch Change Day” which includes an “off week”—Week Four—wherein a woman is not to wear the patch. In months where Week Four falls on a week wherein a calendar month ends and a subsequent calendar month begins, a great disadvantage flows from the traditional calendar graphics which break calendar months into separate visual presentations by placing the last day of the month and the first day of the subsequent month in separately presented weeks. When scheduling the prospective use of the contraceptive patch, which is to be administered on a weekly cycle, this traditional visual presentation of a calendar is confusing since the traditional calendar presentation show some weeks on two lines. This presentation can lead to improperly scheduling the future application of the patch, which in turn can lead to a woman unknowingly being at risk of pregnancy due to such an error, when undiscovered.

Another disadvantage of existing systems is that there are no simple presentations of drug risks related to future usage, especially when future usage is affected by an alteration of an existing drug usage regimen. While some current systems are able to calculate a future dosage of a drug when a user has taken a drug early or late, and can regulate the taking of a drug based upon such calculations, there are no systems which are able to calculate when a drug user is subject to risks based upon prospective dosages.

While there are systems which enable a doctor or a pharmacist to provide a patient with drug usage schedules and calendars, these programs are designed such that only highly trained professionals can enter information into the system in the event that there must be an alteration in a drug usage regimen. At best, the current systems allow an actual drug user to enter information based on past compliance with a drug usage regimen. These systems are inadequate at allowing a drug user or a caretaker to prospectively alter or plan singular drug usage or a multiple drug usage regimen even in those situations where a non-professional has the discretion to do so.

A need exists for a system and method to provide a clear and simple presentation of future drug use in accordance with a prospective drug usage schedule.

A further need exists for a system and method to provide an individualized future drug usage schedule, dosage instructions, administration instructions, and risk information for a person using a drug.

A visual presentation which is capable of displaying the time periods for risks and future drug use in the event of prospective altered drug usage is needed and beneficially provided by the present invention.

### SUMMARY OF THE INVENTION

This invention provides a method of visually presenting future drug use where a subject's usage of a drug is altered. The method comprises selecting a drug associated with a predetermined Digital Patient Information (DPI). The DPI comprises a set of rules for a drug and educational information about the drug. The method is carried out by identifying a first start time for a drug, calculating an initial future drug usage period from the DPI and the first start time, and visually presenting the future drug usage period, on an automated calendar. At least one subsequent start time for the drug is then identified; whereupon the method includes calculating a subsequent future drug usage period from the digital patient information and said subsequent start time. Also included in the method is calculating a risk period associated with the future drug usage period from the digital patient information, the first start time, and the at least one subsequent start time; and visually presenting the subsequent future drug usage period as well as the risk period on the automated calendar. The automated calendar can be presented as a linear calendar.

The above mentioned method further comprises storing in a memory a drug state data for at least one subject's drug usage. This memory is optionally remotely located. In the method a subject's drug state data is accessible by any number of parties, such as a pharmaceutical company, a health care professional, a health management organization, an insurance company, a caretaker, a party authorized to access the subject's drug state data, or a subject's family member. The subject's drug state data is grouped by the subject's characteristics, such as family relationships with other subjects using the system. Any of these parties can offer recommendations based on the drug state data. For example, a pharmaceutical company can recommend purchases of pharmaceutical products.

The method can further provide for visually presenting educational information from the DPI. Educational information such as instructions to aid in administering the drug to the subject can be visually presented. A specific issue could be addressed by visually presenting the instructions. For example, risk information related to contra-indicated drugs, side effects, or physical condition or instructions to aid in administering the drug to the subject can also be visually presented. An exemplary risk is where the drug is a contraceptive delivered to a subject in the form of a patch; and the risk period is associated with a risk of pregnancy.

Exemplary instructions include the instance where the drug is a contraceptive patch and the specific issue to be addressed includes the patch being off or partially off a subject for a predetermined time period, said patch having been previously applied to the subject; not changing the patch within a predetermined time period; not removing the patch; not administering a first patch on a required start date; or correctly applying the patch to the skin of a subject.

A system is provided for visually presenting future drug use resulting from altered usage in a subject comprising a computer executable program and a program memory for storing DPI, said DPI comprising educational information for a drug. The program, when executed by a processor, is structured to accept via an input data identifying the drug associated with the digital patient information, accept via the input a first start time for the drug, and calculate an initial future drug usage period from the digital patient information and the first start date. The system then can transmit via an output to a display a visual presentation of the initial future drug usage period in a calendar format. Data identifying at least one subsequent start time for the drug is inputted, whereupon the system calculates a subsequent future drug usage period from the DPI and the at least one subsequent start time. The system calculates a risk period associated with the future drug usage period from the DPI, the initial start time, and the at least one subsequent start time which is then transmitted via the output to the display a visual presentation of the subsequent future drug usage period, wherein said subsequent future drug usage period is displayed in the calendar format. Also transmitted via the output to the display is a visual presentation of a risk period associated with the subsequent future drug use period, wherein said risk period is displayed in the calendar format. A preferred calendar format is a linear calendar.

The system's program, when executed by a processor, is further structured to store drug state data for at least one subject's drug usage in a memory. The memory is stored in a secure environment. The memory can also be remotely located.

The subject's drug state data can be accessible by at least one party. The subjects' drug state data is grouped by the subjects' characteristics such as family relationships between individual subjects. The parties can be any one or a number of a pharmaceutical companies, a health care professional, a health management organization, an insurance company, a caretaker, an party authorized to access the subject's drug state data, or a subject's family member. A party can offer recommendations based on the drug state data, as, for example, where the pharmaceutical company recommends purchases of pharmaceutical products.

The program, when executed by a processor, is further structured to transmit via the output to the display a visual presentation of the educational information from the DPI. The visual presentation of the system can be in the form of a multi-media presentation. Exemplary presentations include a video presentation, pop-up windows, an audio presentation, at least one animated graphic, or hyperlinks to the “internet”. The system's program can be structured to be executed by a processor in any number of forms, including a personal computer; a personal digital assistant; a cell phone; a kiosk; a digital watch; or a drug dispensing device.

Visual presentations of the educational information include instructions to aid in administering the drug to the subject the method. The program, when executed by a processor, is further structured to accept via the input data identifying a specific issue to be addressed by visually presenting the instructions. Educational information includes information about risks associated with the drug. Risks include contra-indicated drugs, side-effects, or risks related to the physical condition of the subject. Where the drug is a contraceptive delivered to a subject in the form of a patch, the risk period can be one associated with a risk of pregnancy. Again, where the drug is a contraceptive patch, the specific issue to be addressed can include the patch being off or partially off a subject for a predetermined time period, said patch having been previously applied to the subject; not changing or removing the patch within a predetermined time period; not administering a first patch on a required start date; or correctly applying the patch to the skin of a subject.

### BRIEF DESCRIPTION OF THE FIGURES

FIG. 1 is an overview of the computerized system usable to implement the present invention.

FIGS. 2A to 2D are diagrams showing the basic invention as carried out within the system.

FIG. 3 illustrates Step-by-Step instructions as delivered to a user by the system.

### DETAILED DESCRIPTION OF THE INVENTION

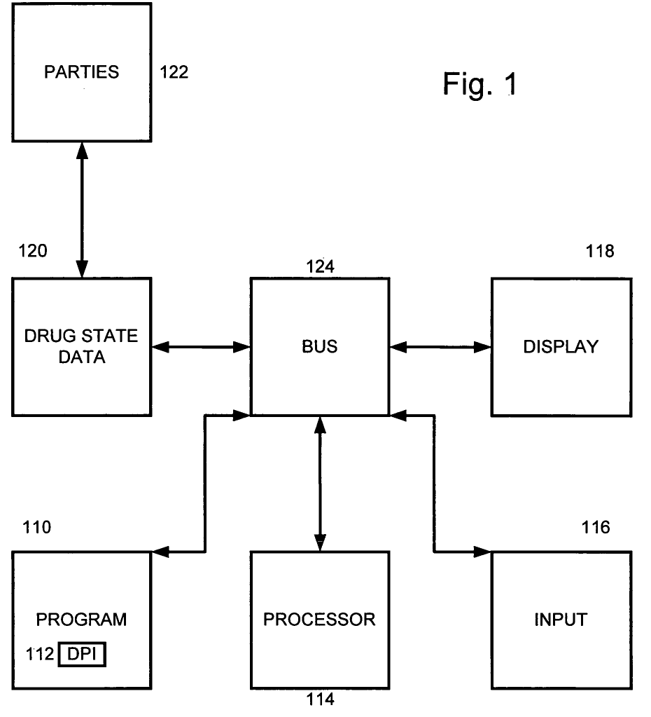

Referring now to the drawings, attention is first directed toward FIG. 1 wherein the computer system in which the computer program is operably connected is described. As illustrated in Step 110 is a computer program that uses information relating to certain drugs. The drug information can be conveniently stored in a uniform data module containing predetermined Digital Patient Information (DPI) about a drug. The DPI would include program instructions or rules for implementing the functions of the program such as well as educational information about the drug. Exemplary DPI educational information about a given drug is included, but is not limited to, risk periods associated with the drug, side effects, or such information as one would find in the drug manufacturer's own literature.

As illustrated in FIG. 1, the system for visually displaying future drug use resulting from altered drug use (the system) 1 is described. The system 1 comprises a number of system components, namely: a computer program 110 which includes predetermined DPI about a drug 112. The DPI 112 would include rules for implementing the future drug usage functions of the program as well as educational information about the drug. Exemplary educational information about a given drug includes risk periods associated with the drug, side effects, and such information as one would find in the drug manufacturer's own literature. Exemplary rules or program instructions for implementing future drug usage could include a rule for generating an initial drug usage schedule based upon data representative of the effective use of a drug and commands for generating a subsequent drug usage schedule based upon data representative of the effective use of the drug when there is an alteration in the initial drug usage schedule. For example, if drug use is for the Ortho Evra™ contraceptive patch, a DPI rule would cause the system to indicate that a subject should be wearing a patch for three weeks and not wearing-one in the fourth week; and that while she is wearing the patch she should change her patch on the same day of each week. One or more graphically displayable prescribed drug usage periods and risk periods can be displayed in a linear calendar form based upon the DPI.

A linear calendar form means that the calendar, when displayed, is capable of displaying the weeks of multiple months in a contiguous fashion without a visually displayed break between the months. Thus if, in the period of a visually displayed week, the last day of the month fell on a Tuesday and the first day of the subsequent month fell on a Wednesday, the calendar graphic would display the week in which these two days fell as a contiguous week.

The system also includes an input 116 for manually inputting data to be used in generating a calendar which displays future drug usage period as well as providing drug information to a user of the system 1. At Step 114 is shown a processor for running the program. The processor would also include a timer/controller (not shown) for maintaining accurate measurement of standard-time and future drug use and for performing various programming and control functions in accordance with the program 110. The system includes a display device 118 for visually presenting a future drug use calendar and educational information about the drug. Also provided is a memory for storing drug state data 120 about a subject using drugs (subject). The system 1 stores information about the drug use of a subject entered into the system 1. Parties 122 interested in the subject's drug use can have access to the drug state data 120 so as to provide recommendations or otherwise help manage the subject's drug use. Parties 122 accessing the drug state date include: pharmaceutical companies, health care professionals, health management organizations, insurance companies, caretakers, family members, or parties authorized to access the subject's drug state data. [As illustrated, drug state data 120, DPI 112, the program 110, processor 114, input device 116, display device 118, and parties 122, are operably associated by way of a bus 7.]

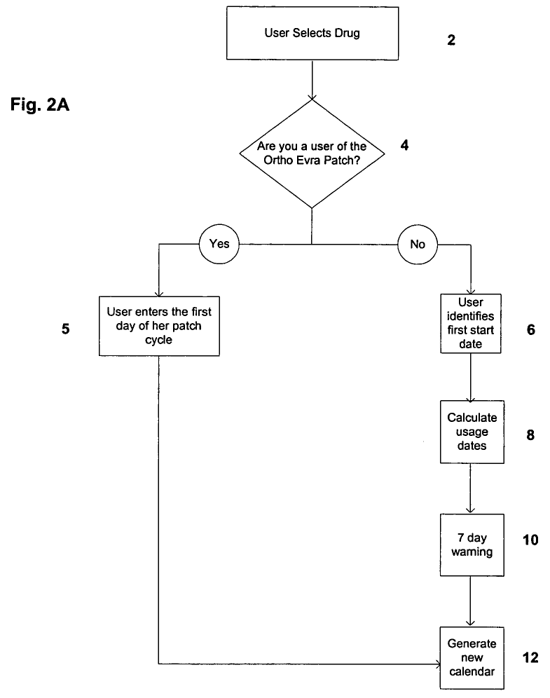

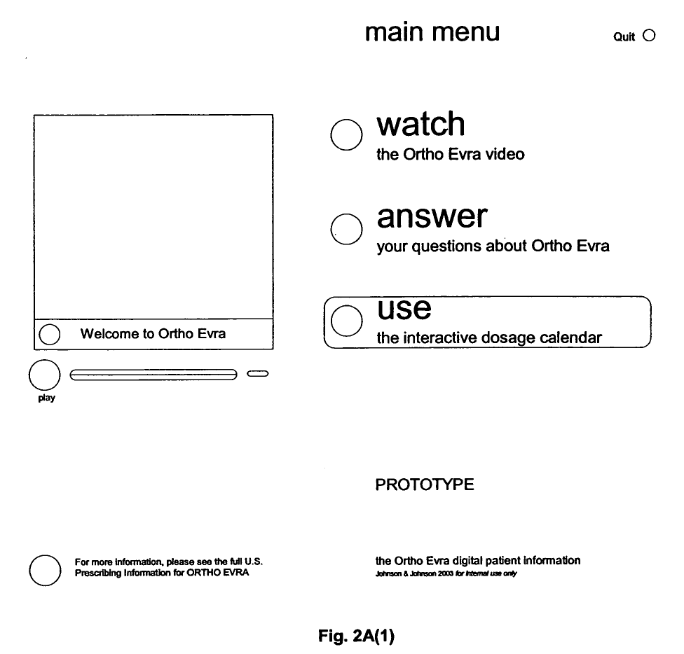

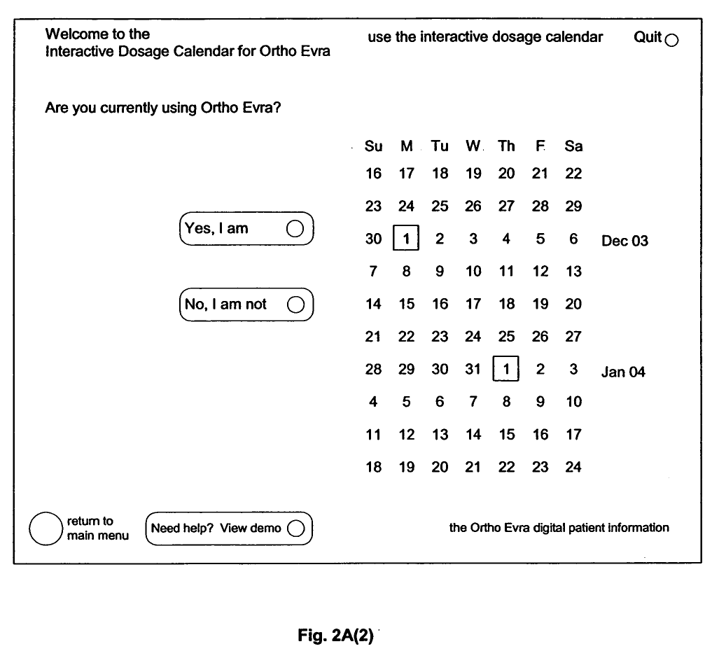

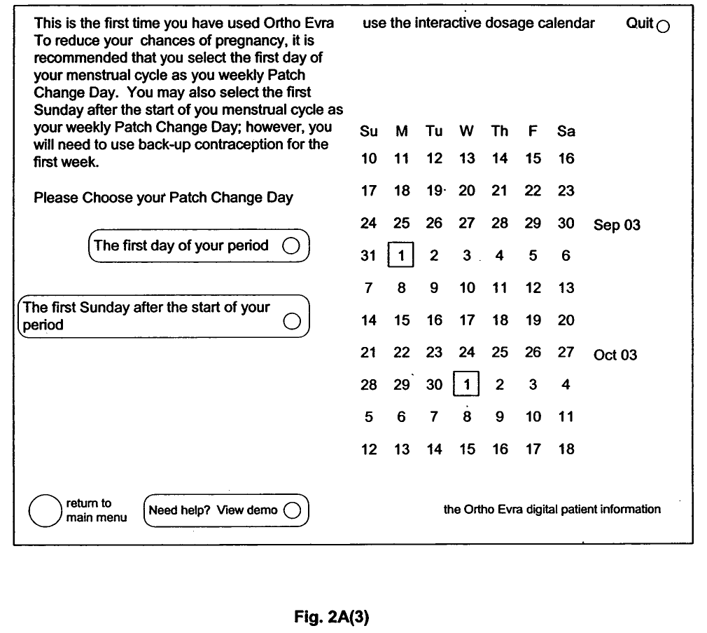

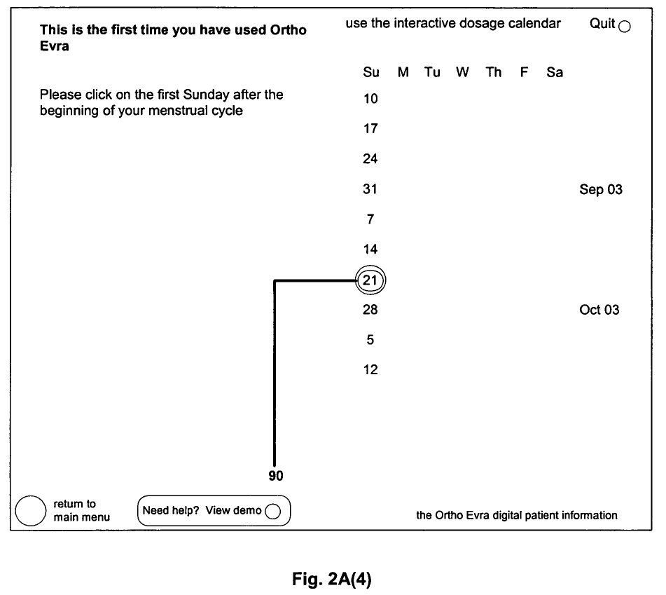

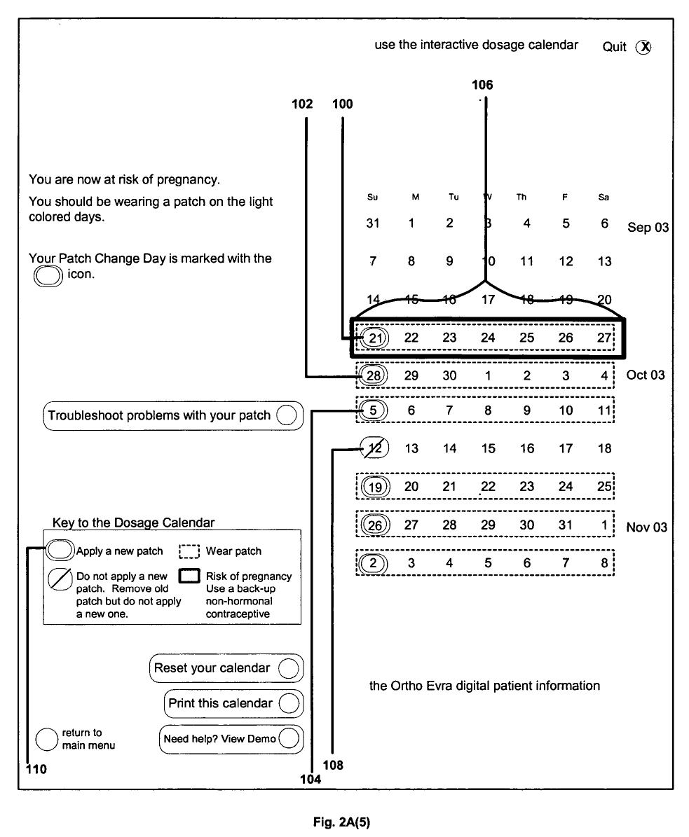

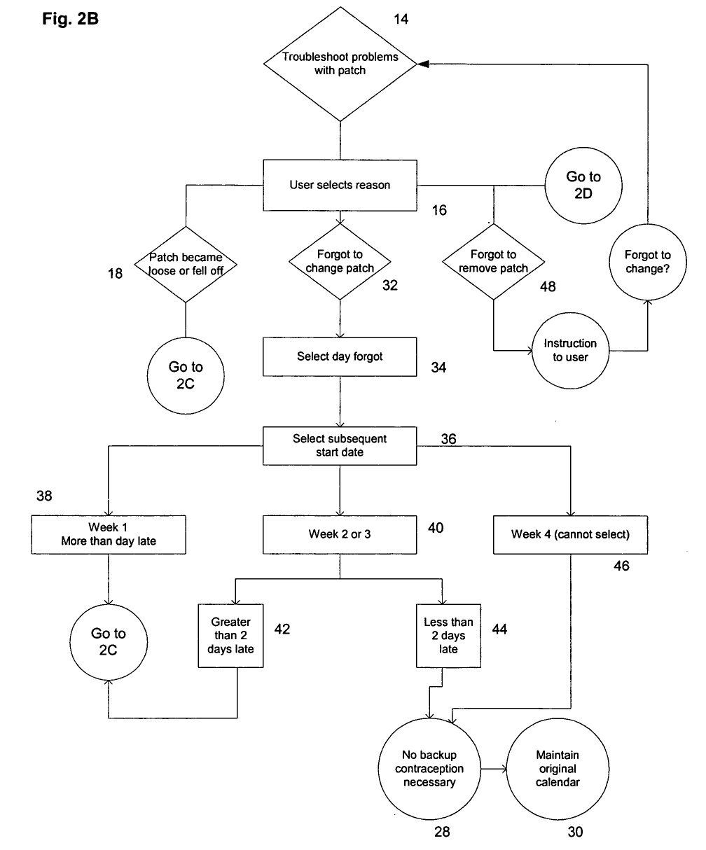

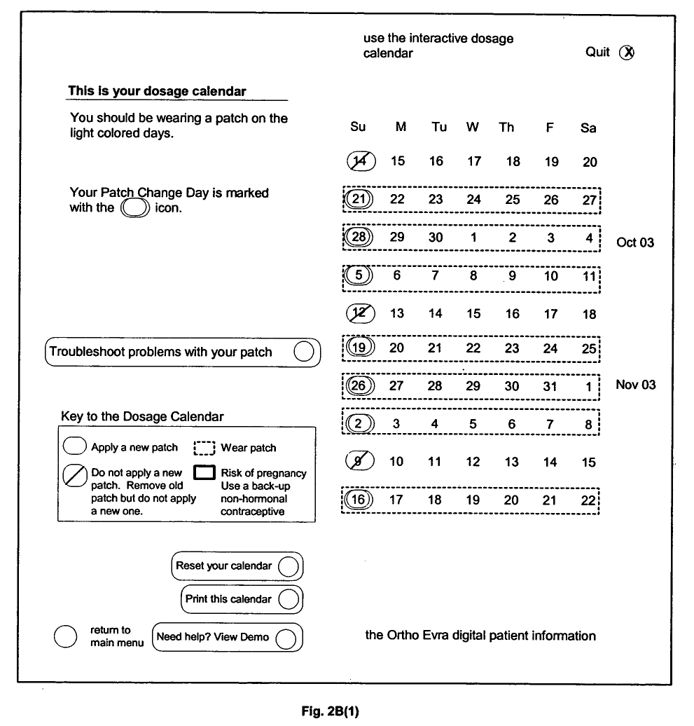

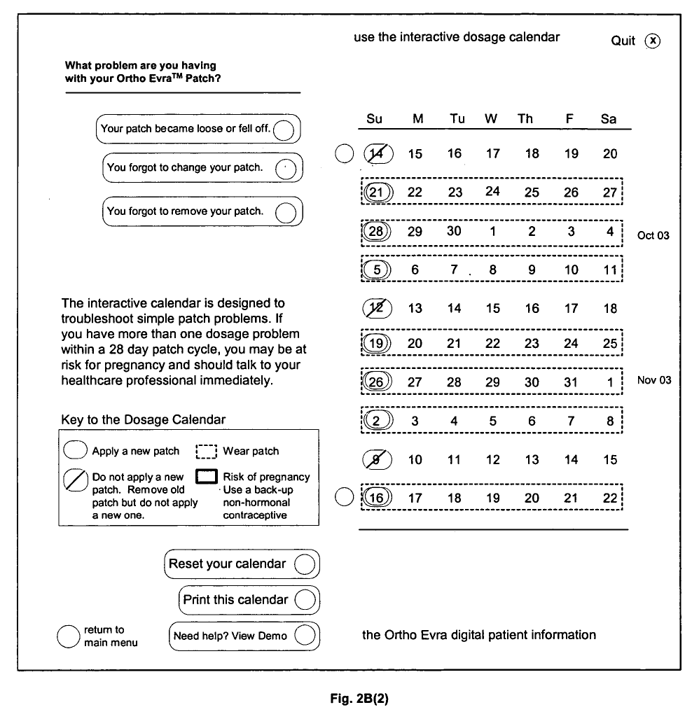

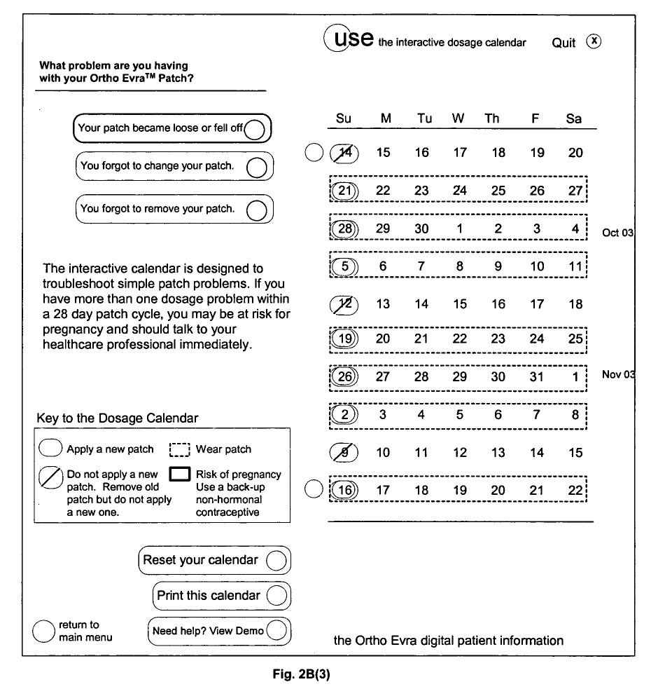

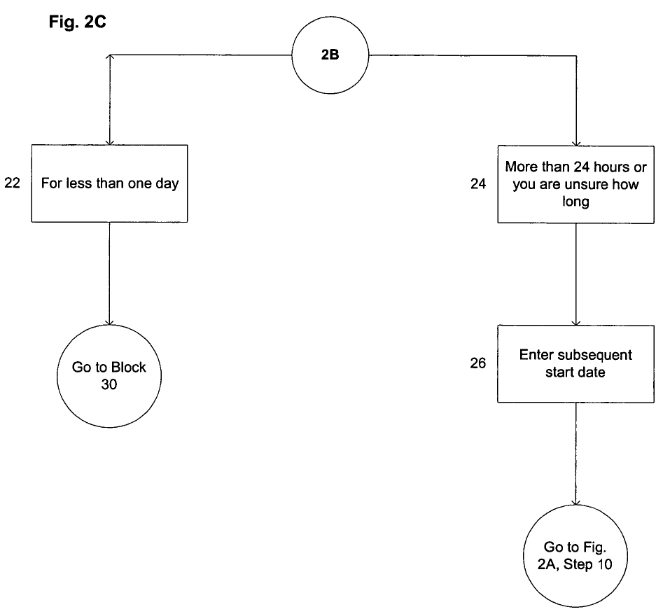

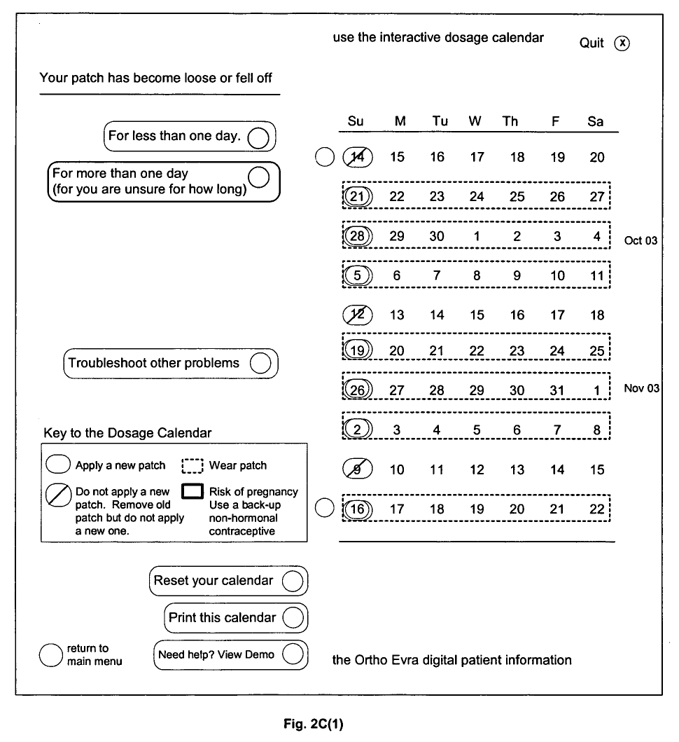

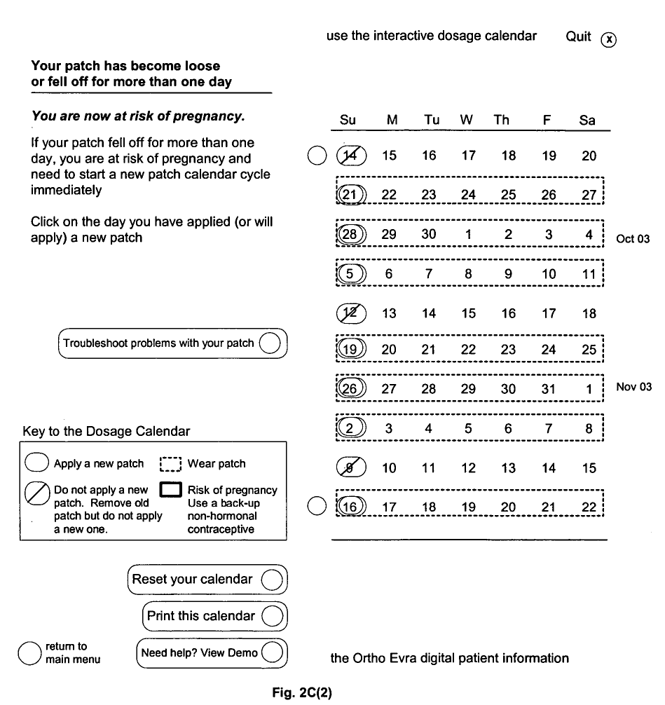

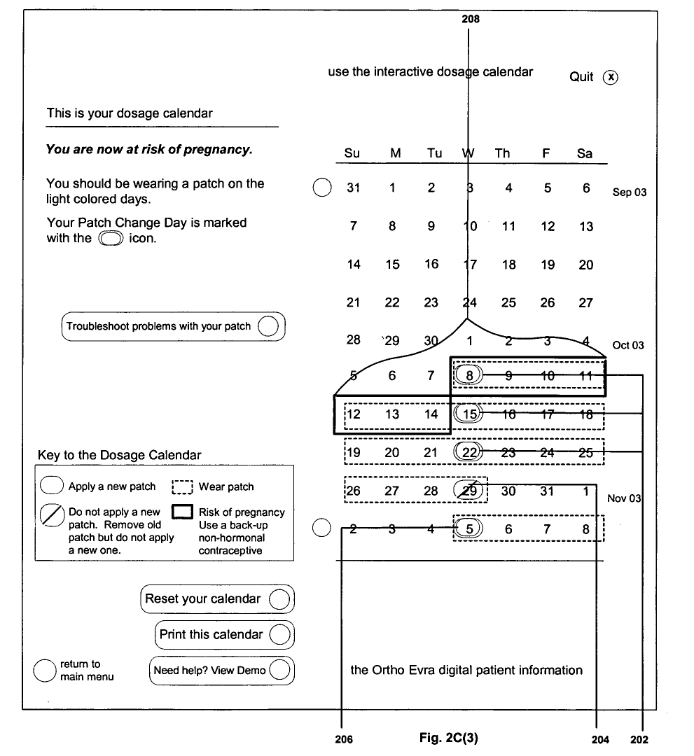

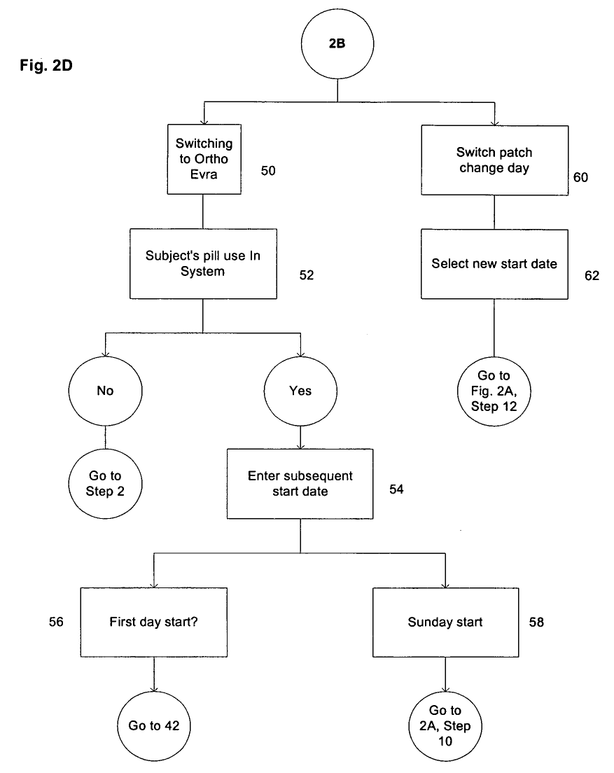

The program enables a user to carry out the method of the invention, the steps of which are described in Steps 2 through 62 of FIGS. 2A to 2D. Oftentimes a user and a subject will be the same person, the subject being the one actually using the drug and a user being a user of the invention. A user of the system and a subject need not, however, be the same person, as would be the case where the user is a caretaker for a subject using a drug. In the described embodiments it is assumed that the user and the subject are the same person. Turning to FIG. 2A, at Step 2 the user selects a drug, for example the Ortho Evra™ contraceptive patch (the patch), associated with predetermined DPI. The selection of the drug can be done simply by running a program memory storage device such as a compact disc (CD), a memory card, or diskettes containing a predetermined DPI, such as a CD provided with the Ortho Evra™ contraceptive patch. At FIG. 2A(1) is shown the interactive opening screen that is presented on a display when a CD provided with the Ortho Evra™ contraceptive patch is run. Also contemplated is selecting the drug from amongst multiple drugs, as could be presented on a website accessed by a user over the Internet. A user could also download a file with the DPI onto a computer. At FIG. 2A, Step 4 the user is asked if she is a user of the Ortho Evra™ patch; the interactive screen for this step is shown at FIG. 2A(2). If the user enters a negative response, at FIG. 2A, Step 6, a user identifies a first start date for a subject who will be taking the drug by selecting or entering a calendar date. As demonstrated at FIG. 2A(3), a user is offered the option of a “Sunday Start” for the patch, meaning the subject applies the patch on the first Sunday after beginning her menstrual period, whereupon she selects and enters the day “Sunday, Sep. 21, 2003” into the system as shown at FIG. 2A(4). The user could also choose a “First Day Start”, meaning that the subject applies the patch during first twenty-four hours of her menstrual period, regardless of what day of the week it is. In a preferred embodiment of the method, a user is presented with a linear interactive dosage calendar for which a user can be prompted to enter a date by “dragging” a patch icon 90 representing the Ortho Evra™ patch onto the desired start date using a mouse as an input device, as is shown as FIG. 2A(4).

The method moves to FIG. 2A, Step 8 and, using the rules or program instructions in the DPI, calculates a projection of the calendar dates for the period over which the drug is to be used or taken based upon the first start date. The rule causes the system to calculate a patch change day after every seven days for fifteen days (Week One to Week Three), including the first administration (e.g. Day One is marked as the first patch change day, day Eight the second patch change day, day Fifteen the third patch change day.) The rule would further indicate that on Day Twenty-two (Week Four), a patch is to be removed, but a new patch is not to be applied until Day Twenty-nine. Day Twenty-nine then repeats the cycle as the next “Week One”. The rule thus indicates that a subject removes the old patch and applies a new patch on the same day every week for three weeks and removes, but does not apply, a patch every fourth week, and then applies the patch on the same day of the week on the subsequent week, which for the user is a new Week One. In accord with the method, at Step 10 the system would also calculate a risk period based on the DPI. Where the DPI is for the Ortho Evra™ patch, a seven day warning based on risk information in the DPI calculation indicates that a patch user should use non-hormonal back-up contraception such as a condom, spermicide, or a diaphragm on the first seven days of use in order to avoid the risk of pregnancy.

If the user indicates that the subject is a user of Ortho Evra™ patch, the method moves to Step 5, where a user identifies the date a subject's first day of her patch change day by selecting or entering a calendar date by dragging the patch icon onto a calendar graphic in the manner already described.

At Step 12 the method is illustrated as the system visually presents on a display a display graphic of a linear calendar which shows the future drug usage period of a user who is using the drug, in this case the Ortho Evra™ patch, for the first time. The linear calendar display screen is shown at FIG. 2A(5). The linear calendar contiguously displays the days of the week in which a month changes as has already been described. For a user of the Ortho Evra™ contraceptive patch the calendar would show the projected start date as Sunday, Sep. 21, 2003, 100, the date input into the system at FIG. 2A, Step 6. Based upon the calculations in Step 8, the displayed calendar would show that a user of the patch would change her patch on the eighth (Sep. 28, 2003, FIG. 2A(5), 102) and fifteenth (Oct. 5, 2003, 104) day after the initial start date. As a result of the calculations at FIG. 2A, Step 10, the calendar display indicates to the user that in the first seven days of use is a risk period, which it can do in any number of ways. In a preferred embodiment, the display highlights the first seven days, Sep. 21, 2003 to Sep. 27, 2003, by surrounding the cells representing the days with a red block FIG. 2A(5), 106 indicating that these days are a pregnancy risk period. Links or text could also be embedded or displayed on the calendar informing the patch user to use non-hormonal back-up contraception during this time. The program display would also show that on the twenty-second day of use, Oct. 12, 2003, 108, the user should not change the patch, and optionally that her menstrual period should begin in that week. In a preferred embodiment, this is done with a icon indicating that a subject is to remove the old patch but not apply a new one, 110.

Had the user chosen to enter a patch change day upon indicating that she was already an Ortho Evra™ patch user, as shown at FIG. 2A, Step 5, the calendar would not show any risk periods, but instead calculates generates a calendar showing a cyclic dosage regimen indicated by her patch change days. The program could be optionally configured to generate a calendar showing current and past risk periods based upon past drug usage as well as future drug usage.

In accord with the method, the system is optionally capable of generating any number of risk periods for any risk associated with drug use, as well as indicating to the user any other risks associated with the prospective drug use. For example, as an Ortho Evra™ patch user should not have the patch off for more than seven days, the calendar could display a risk period based on this information. During the seven day period in which the user is not to wear the patch, the week could, for example, be displayed in any color, blue for example, and next day for applying the patch, Oct. 19, 2003, could display some icon indicating that this is the day on which she must apply a patch in order to maintain the contraceptive effect of patch usage and not increase the risk of pregnancy. In a preferred embodiment, the days to apply a new patch are marked with a patch icon; the days on which a patch should remain on a subject could be displayed in beige.

As a further example, serious and even life threatening risks are increased if a subject uses the Ortho Evra™ patch—the norelgestromin/ethinyl estradiol transdermal system—while smoking. The system could be optionally configured to ask the user for personalized information, including whether a subject is a smoker. Using this information, the system could, in accord with the method, produce a risk period warning graphic, either in a pop-up window displaying a text warning or on the linear calendar as a warning graphic that extends over the entire use of the patch. The system could also be configured to display warning graphics to a user indicating other side effects associated with the Ortho Evra™ patch, such as breast symptoms, headache, skin irritation at the application site, nausea, upper respiratory illness, menstrual cramps, and abdominal cramps. The system could also be configured to warn the user that the contraceptive patch does not protect against HIV or sexually transmitted diseases. A risk warning may be generated based on information relating to a subject's biological condition, for instance, a subject who has a history of breast cancer in the family or who has depression would be warned to consult with a health care professional before using the patch, or a woman who was pregnant would be warned not to use the patch at all.

A woman using the Ortho Evra™ contraceptive patch, after first applying it, is able to establish a “Patch Change Day”, where she will be able to change the patch on the same day every week, except in the beginning of Week Four of use-day twenty-two after the first day of drug use—where she may remove the patch and need not apply another until the subsequent “Patch Change Day”. Week Four is known as the end of the cycle, the beginning of the cycle being the time when she first applies the patch (Week One, Day One). In the instant example, based upon the dates entered at Step 6, the subject's prospective “Patch Change Day” is on Sunday, and the last week of her cycle begins on Sunday, Oct. 12, 2003.

As can often happen in any drug use, proper usage of a drug is subject to interruption or alteration based upon any number of discrete circumstances. As such, the present invention is designed to generate linear calendars for visually presenting future drug use based upon altered drug use. Altered drug usage as used herein is broadly defined to encompass any change in a drug taking regimen, whether for cyclic or non-cyclic drugs, whether the change be a late administration of the drug, an early administration, a missed administration, an interrupted or uninterrupted administration, or even undertaking a wholly new drug usage regimen.

At FIG. 2B is shown the method wherein a user identifies a new, subsequent start date for using the patch. The method is illustrated as the system at this point prompts the user to select a reason for entering the subsequent date, as shown at Step 14. In a preferred embodiment the system is designed to first present a “troubleshooting page” or a “Frequently Asked Questions” page within the program memory where a user may select from a menu the reason for entering a subsequent start date for patch use prior to selecting the date itself. Such pages are shown at FIGS. 2B(1), which shows an icon leading to a troubleshooting page, and 2B(2), wherein the troubleshooting page is presented. At FIG. 2B Step 16 the user enters or selects reasons for the subsequent date entry by, for example, choosing from a menu presenting these reasons. The menu, shown at FIG. 2B(2), presents the reasons: “Your patch become loose or fell off”, “You forgot to change your patch”, and “You forgot to remove your patch”. A user may optionally be provided with the choices “Switching from my other birth control pill to Ortho Evra™” and “Switch Patch Change Day”.

At FIG. 2B, Step 18 the user selects the reason “Patch became loose or fell off”, also shown at FIG. 2B(3). At FIG. 2B, Step 20 the system prompts the user from two choices, shown at FIG. 2C: “For less than one day”, Step 22, and “More than twenty-four hours you are or unsure how long”, Step 24. The visual display of these two choices are shown at FIG. 2C(1). If the user selects the “more than one day” option, FIG. 2C, Step 24, the system will prompt the user to enter a subsequent start date as shown at Step 26, warning the user that she is at risk of pregnancy and must start a new calendar cycle, also shown FIG. 2C(2).

As demonstrated at FIG. 2C(3), the system, using the rules or program instructions in the DPI, calculates a projection of the calendar dates for the period over which the drug is to be used or taken based upon the subsequent start date. Using the example of the Ortho Evra™ patch, the DPI causes the system to calculate three patch change days, 202, including the first administration day. The DPI would further indicate that on Week Four, a patch is to be removed, but a new patch is not to be applied until the following week, 204; the following week then repeats the cycle as the next “Week One”, 206. The DPI thus indicates that a subject removes the old patch and applies a new patch on the same day every week for three weeks and removes, but does not apply, a patch every fourth week, and then applies the patch on the same day of the week on the subsequent week, which for the user is a new Week One. The system will then generate a calendar based upon the new date and the parameters as already described in FIG. 2A, Steps 10 and 12, which includes the seven day warning, FIG. 2C(3), 208. If the user selects the “less than one day” option, FIG. 2C, Step 22, the system may inform the user that no backup contraception is needed, shown at Step 28 and maintain the original calendar, illustrated by Step 30, as generated based on the initial start time, identified at Step 6, and the DPI. Since the system knows, by virtue of the user's input of the information that the patch has been off or partially off for more or less than twenty four hours, it can project future drug use for a subject based upon that information, and, if the patch may have been off or partially off a subject for more than twenty four hours, the entry of a new usage period is generated based on the input of that information as well as the subsequent start date.

Returning to FIG. 2B, at Step 32 is illustrated the method of operation where a user selects the option “Forgot to Change Patch”. In accord with the method, the system already has the subject's initial start date as was entered at Step 6 (although the system employing the method could optionally prompt the user to confirm whether that first start date is still accurate; and if it is not, the user could be directed to enter a first start date as shown at Step 6). In a preferred embodiment, the method moves to have the user select the day she forgot to change her patch at Step 34. Since the system already knows the “patch change days”, the DPI would not allow a user to select any day other than her “patch change day”. If a user originally selected a “Sunday Start”, the only day a user could select would be a Sunday. After the user selects the day she forgot to change her patch, the method progresses Step 36 to having the user select a subsequent start date, which may be in the past (in the event the subject previously reapplied the patch) or the future. The system carrying out the method moves to generate a linear calendar graphic using the first start date, the subsequent start date, and the information in the DPI as described below.

In a preferred embodiment where the Ortho Evra™ patch DPI is used, the method processes by generating a linear calendar using the first and subsequent start dates and the DPI. If the system calculates that the subject is in Week One of her cycle and she is more than one day late in applying her patch for the first time, Step 38, the system, the DPI will calculate a calendar showing that the subject's patch change day is the subsequently selected date and generate a linear calendar as shown in Steps 10 and 12, which includes the seven day pregnancy risk warning.

If the system calculates that the subject is in Week Two or Three of her cycle, Step 40, and if she is greater than two days late in changing her patch, Step 42, the system will also calculate a calendar showing that the subject's patch change day is the subsequently selected date and generate a linear graphic calendar as shown at Steps 10 and 12. If the system determines that the subject is less than two days late, Step 44, in the second or third week of her cycle, Step 40, the system will visually display the calendar graphic as shown at Steps 28 and 30, although in a preferred embodiment the subsequent start date will be marked with a patch showing the dosage application on that day, but otherwise will not change the subject's original patch change day.

If the subject is in Week Four, Step 46, of her cycle, the system will visually present a calendar graphic as shown in Steps 28 and 30, in which case the calendar graphic will show that the subject is in a week where she need not be wearing her patch. As such, in a preferred embodiment, a DPI system rule or program instructions could preclude the selection of a subsequent start date; that is to say the user would not even be given the option to select a date in Week Four in which she “forgot to change” her patch. Thus the system may optionally display a graphic to the user indicating that the subject need not apply a patch until her next regularly scheduled “Patch Change Day” (not shown). The rule or program instruction which precludes the selection of a subsequent start date for the use of the patch indicates that the system rule identifies the subsequent start time as being non-existent in Week Four when the subject “Forgot to Change Patch”, and the subsequent usage is in fact the same as the initial usage. This is only possible since the system blocks the user from selecting a subsequent start time in Week Four. The same result would be accomplished if the user in fact was allowed to select a date in Week Four, as the system would in that event calculate a drug usage period that would be identical to the initial drug usage period based on the entry of the subsequent date and the systems knowledge of the original date. Thus the identification of the subsequent date and the calculation of the drug usage based thereon is contained in a rule or program instructions precluding the user from selecting of a subsequent start time in Week Four when the user selects “Forgot to Change Patch”. If the user indicates that she forgot to remove the patch, Step 48, then she will be shown a graphic which instructs her that if she is in her patch free week (Week Four), Step 46, she needs no back up contraception, Step 28, and the original calendar graphic is maintained, Step 30. The instructions also indicate to the user that if she forgot to change her patch (meaning that she is not in a patch free week) that she should return to the troubleshooting screen (Step 14) to where she can be directed to select that option, Step 32.

Optional selections which could be offered to a user are shown at FIG. 2D. Step 50 illustrates another embodiment of the method wherein the user selects the option, “switching from my other birth control pill to Ortho Evra™”. At Step 52, in accord with the method, the system attempts to determine if the subject's other drug use, a birth control pill, is in the system. In one embodiment, the system is optionally designed to store in memory the DPI for multiple drugs. As such, DPI for multiple drugs could be present or downloaded into the system. The result is that the system may contain the times for a subject's drug usage related to the birth control pill, a drug use profile for the subject's use of the birth control pill, or indeed, the entire drug usage profile of a subject which includes, among other things, the entire drug regimen of a user. Furthermore, the system could be designed to hold the drug usage profiles of multiple users, and is further designed to index multiple users' drug usage data by any conceivable category, such as family relationship. In a system with this capability, at Step 52 the method moves to determine if the DPI associated with the birth control pill and the subject's first start time of that pill use are already available in the system. If not the user is directed to select the birth control pill as the drug selection at Step 2 as well as identify a first start date as shown at Step 4 for that drug, as shown in FIG. 2A.

Once the birth control drug and the first start date are available to the system, a first calendar date future drug usage period can be established, as has been previously described, at which point the user can begin entering the “switching to Ortho Evra™” again at Step 50. In the event that a user is unable to select or enter the prior birth control of the subject into the system, the system may nonetheless progress in accord with the method where the method is used for birth control drugs. This is due to the fact that, as regards dosage cycles, the instructions given the user with respect to a subject switching from a prior birth control pill to the Ortho Evra™ patch are substantially the same. So long as the user indicates the dates of the prior birth control pill use, the exact drug of the birth control pill is not necessary. Thus if the user does not know or cannot select the exact prior birth control pill, it is enough to indicate that a birth control pill has been used.

Once the user has entered or selected the other birth control pill into the system, or has otherwise calculated calendar dates based upon prior birth control use, the method progresses based upon a positive determination that the prior birth control pill use is in the system. At Step 54 the system prompts the user to enter a subsequent start date in the manner already described. In accord with the method, the system then determines if the subsequent start date, entered at Step 54, is a “First Day Start”, Step 56, or a “Sunday Start”, Step 58. If the user has entered a “First Day Start”, Step 56, then original graphic linear calendar of Step 30 is maintained, the existing calendar indicating that no backup contraception will be necessary, as shown at Step 28. If, however, it is determined that the user has selected a “Sunday Start”, Step 58, the system then generates the pregnancy risk period as indicated at Step 10 and generates a new linear graphic calendar as shown at Step 12.

If the user selects “Switch Patch Change Day”, Step 60, the method moves to instruct the user that the subject should complete her current cycle, the first three weeks of wearing the Ortho Evra™ patch, and that during her patch free week, Week Four, she may select an earlier day by applying a new patch on the desired day as shown at Step 62. The system could be designed to preclude the user from entering a switch patch change day that is not in Week Four. In this manner and in accord with the method, the system would then generate a new linear calendar as shown in Step 12 of FIG. 2A, based upon the first date, Step 6, the subsequent date, Step 62, and information in the DPI. The linear calendar would indicate to the user that she should change her patch on the newly selected day entered at Step 62. As there is no increased risk of pregnancy, which is determined as a function of the DPI, the first start date, Step 6, and the second subsequent start date, Step 62, the method progression will not generate any new risk period information, or could optionally indicate to the user that no backup contraception is necessary based on the date selected.

In an optional embodiment, the system is configured to indicate to a user all contra-indicated drugs and can generate risk periods on the linear calendar indicated the times periods for those contra-indicated drug interactions. For example, if a subject is taking Phenobarbital to treat epilepsy, or an anticonvulsant such at topiramate, and also wishes to use the Ortho Evra™ patch, a risk period could be generated for the time period associated with the effective period of the contra-indicated drugs warning that the Ortho Evra™ patch may be less effective in preventing pregnancy or there may be an increase in breakthrough bleeding due to a drug interaction.

The system is preferably configured to instruct a user in administering the treatment. The DPI would contain program instructions and educational information for generating instructions for administering the prospective drug treatment. For example, in a preferred embodiment a user desiring instructions on how to administer the Ortho Evra™ contraceptive patch would be presented with the menu option “Using the Ortho Evra™ patch”.

The system would then access the DPI to present to the user a menu of options with questions related to using the patch. A user could also select the menu option “How do I put my patch on”, whereupon a user could be presented step-by-step instructions on applying the Ortho Evra™ patch in a number of media. The instructions could be presented in any number of media capable of being run on by a computer, including video, audio, animated or stationary graphics, or even simple text.

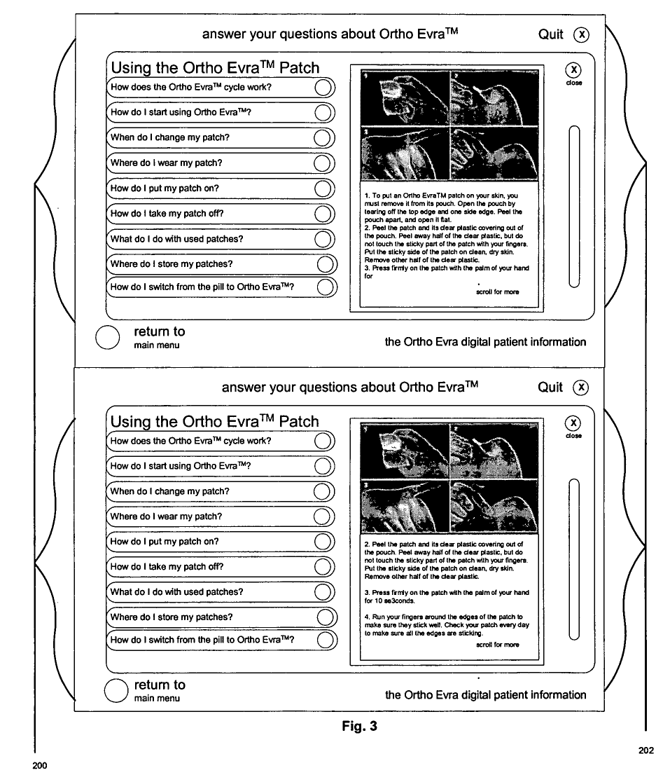

Step-by-Step instructions as delivered to a user by the system are illustrated in FIG. 3. An image 200 displaying a menu is presented to the user, where the user chooses from menu selections in the form of a number of frequently asked questions to begin the process. If the user wishes to repeat the presentation of a step, she may simply select that step. A section of the display 202 presents to the user a media presentation of the instructions for administering the drug, the media presentation corresponding to the menu option selected. The media presentation could optionally be in the form of a “pop-up” window, or a multi media presentation the execution of which is well known in the art of computer programming. In the display is text corresponding to the selected step instructing the user on administering the drug, for example applying the patch to a subject. Hyperlinks could be optionally embedded into the text to access further information in the DPI or even be linked to the “Internet” to enable the user to obtain further information related to the drug. Other media that could be optionally included in the step-by-step instructions includes audio and animated graphic presentations.

Step-by-step instructions as shown in 202 are delivered by the system. At step 1 the system instructs the user on how to open an Ortho Evra™ patch containment pouch. At step 2 the system instructs the user on how remove the patch from the pouch, how to peel a clear plastic covering from the patch, and how to place it onto the skin. At step 3 the system instructs the user to press firmly on the patch for ten seconds. At step 4 the system instructs the user to run her fingers around the edges of the patch to make sure they stick [to the skin] well and further warns the user to check the patch every day to make sure all the edges are sticking.

The system could be optionally configured to allow a user to enter more detailed, personalized information about themselves or a subject in order to aid in the presentation of information and instructions. Exemplary information includes age, education level, geographical location, race, ethnicity, and primary language. Upon entry of the personalized information the system could be configured to present information to the user in a manner that the user is more receptive to it. For example, if the user's primary language were Spanish, the system could deliver the instructions in Spanish. The system could also have the information presented in video media by a Doctor or other health care professional who is close in age, gender, and ethnicity of the user. Instructions to the user could also be adapted to accommodate the education and literacy level of the user.

In another embodiment the user's drug state data is stored in a memory that is remote or external from a user's computer system. The user can access the data from the remote or external storage. Such remote or external access may be facilitated by a network such as the Internet, or other means of remote access as are well known in the art. The remote memory could also store multiple drug users' drug state data and index that information by any number of conceivable categories. For example, the remote memory could hold the drug state data of individuals in a household, and could index that data by family relationship and address, such information about the drug users coming from any number of sources, including the user's system itself. The remotely stored data is also optionally accessible by third parties such as pharmaceutical companies, insurance companies, health management organizations, caretakers, health care professionals such as doctors, family members, caretakers, or any other party granted access to the information by a subject or one entitled to act on behalf of a subject. Of course, access to drug state data need not be limited to instances where that data is remotely stored, as any party with access could also interface with locally stored data so long as the local computer architecture, well known in the art, supports it.

Third party pharmaceutical companies can optionally be given access to the drug state data of subjects or groups of subjects indexed by various categories as previously described. The pharmaceutical companies may then advertise recommended treatments based on the drug usage data of individuals, family households, subject's caretaker or health care professional, or any other indexed categories of users/subjects. Recommendations for treatments or other health oriented services can also be offered by health care professionals, health management organizations, insurance companies, or any other parties who could advantageously offer services or otherwise beneficially use information based upon drug state data.

The system could advantageously be integrated with the databases of any health related organization or other party. For example, a pharmaceutical database containing the latest information on drugs as well as users could be integrated with the instant invention to provide updated drug education information, which could in turn be used to assure that the DPI is kept up to date and accurate. A Physician's patient databases could also interface with the drug state data maintained by the user so that a physician could keep a highly accurate compliance record, and could even have warnings generated by the present invention based on DPI generated by a physician and tailored to an individual patient's drug use. A Heath Maintenance Organization's database could be integrated with the present invention so as to monitor patient drug use and generate solutions to better economize drug treatment based upon statistical drug usage data stored in the system. Of course, the system can be designed to optimize the privacy of individuals by controlling the level of access and the information available to third parties by, for example, restricting party access based upon access designations, as is well known in the art.

The system can be hosted and run in any number of environments. A user can access the system and have the future drug use graphic displayed in the form of a linear calendar using a personal computer, a personal digital assistant, a cell phone, a watch, a drug dispensing device, or at a point of service kiosk. The computer program can be delivered to a subject/user in any number of means for delivering computer executable programs including memory sticks, or transmission over “the internet” for download into a user's computer system or device. Use of the current system is contemplated in evolving environments embodying computer processing technology and means for storing program memory.

The term ‘drug’ herein is to be broadly construed as any substance or treatment used with the intent to create a beneficial or desired biological effect in a subject. The American Heritage Dictionary of the English Language, Fourth Edition, 2000, defines drug as, among other things, “a substance used in the diagnosis, treatment, or prevention of disease or a component of medication.” The term as used herein is inclusive of and broader than this definition. Indeed the exemplary drug of the present invention is that of birth control, which is taken to prevent pregnancy; and pregnancy is hardly a disease. Nonetheless, prevention of pregnancy by use of a substance may be desired by a subject. Along with pharmaceuticals and biopharmaceuticals, it is anticipated that the present invention would be used for treatments such as medical devices and substances such as vitamins, botanical treatments, or even prescribed dietary treatments and regimens. For example, risk periods based upon mild to severe food allergies could be generated as a function of a dietary regimen. The broad definition of “drug” as used herein contemplates all such uses. It is also anticipated that the invention herein described could also be used for time sensitive health treatments that are not ingested, inserted, appended or otherwise metabolized by the body such as, for example, physical therapy or weight training which is optimally performed on a cyclic schedule and can entail risks if such a schedule is not maintained.

The use of a linear calendar for visually presenting the future drug use offers a significant advantage to a subject and user taking the drug that is especially evident when illustrated by use of the contraceptive patch. As has been described, the cycle of use for the contraceptive patch entails a “Patch Change Day” which includes an “off week”—Week Four—wherein a subject is not to wear the patch. In months where Week Four falls on a week wherein a calendar month ends and a subsequent calendar month begins, a linear presentation of that calendar month makes for an easy and unconfused visual cue for accurately tracking the weekly cycles in which the patch is to be administered. This is because it overcomes the disadvantage in traditional calendar graphics which break calendar months into separate visual presentations by placing the last day of the month and the first day of the subsequent month in separately presented weeks. When scheduling a drug regimen such as a contraceptive which is to be administered on a weekly cycle, this is confusing since the traditional calendar presentation creates the illusion of two weeks where there is only one. This misleading presentation can lead to improperly scheduling the application of the patch, which in turn can lead to a subject unknowingly being at risk of pregnancy due to such an error, when undiscovered.

Additional advantages may be achieved when documents are generated by the system for hard-copies of the information provided by the system, for example, a printout of the visually displayed calendar.

Although the present invention has been described in relation to particular preferred embodiments thereof, many variations and modifications and other uses may be made without departing from the invention. Accordingly, it is intended that all such alterations and modifications be included within the spirit and scope of the invention as defined in the appended claims.

1. A method of visually presenting future drug use resulting from altered usage in a subject comprising:
selecting at least one drug associated with a predetermined digital patient information;
identifying a first start time for administering at least one drug dosage;
determining an initial future drug usage period from the digital patient information and the first start time;
identifying at least one subsequent start time for administering at least one subsequent drug dosage, said subsequent start time being a function of an alteration in the subject's future drug usage; and
determining a subsequent future drug usage period from the digital patient information and the at least one subsequent start time.

2. The method of claim 1 wherein the method further comprises:
visually presenting on a computer display the initial future drug usage period.

3. The method of claim 1 wherein the method further comprises:
visually presenting the subsequent future drug usage period on a computer display.

4. The method of claims 2 or 3 wherein the visual presentation of the periods are in the form of a calendar.

5. The method of claim 4 wherein the calendar is a linear calendar.

6. The method of claim 1 wherein the method further comprises:
storing in a memory a drug state data for at least one subject's drug usage.

7. The method of claim 6 wherein the memory is remotely located.

8. The method of claim 6 wherein the at least one subject's drug state data is accessible by at least one party.

9. The method of claim 8 wherein the at least one party offers at least one recommendation based on the drug state data.

10. The method of claim 9 wherein:
the at least one party comprises a pharmaceutical company; and
the pharmaceutical company recommends purchases of pharmaceutical products.

11. The method of claim 8 where the at least one subject's drug state data is grouped by the subject's characteristics.

12. The method of claim 10 wherein the subject's characteristics comprises a designation of a family relationship.

13. The method of claim 8 wherein the at least one party comprises at least one of:
a pharmaceutical company;
a health care professional;
a health management organization;
an insurance company;
a caretaker;
a party authorized to access the subject's drug state data; or
a family member of the subject.

14. The method of claim 1 wherein the digital patient information further comprises educational information about the at least one drug.

15. The method of claim 14 wherein the educational information includes instructions to aid in administering the at least one drug to the subject.

16. The method of claim 15 wherein the method further comprises:
identifying a specific issue to be addressed by visually presenting the instructions.

17. The method of claim 16 wherein the at least one drug is a contraceptive delivered to the subject in the form of a patch and the specific issue to be addressed includes:
the patch being off or partially off a subject for a predetermined time period, said patch having been previously applied to the subject;
not changing the patch within a predetermined time period, said patch having been previously applied to the subject;
not removing the patch from the subject at a predetermined time period, said patch having been previously applied to the subject not administering a first patch on a required start date; or
correctly applying the patch to the skin of a subject.

18. The method of claim 1 wherein the drug for the initial future drug usage period and the subsequent future drug usage period are different.

19. The method of claim 1 wherein the drug for the initial future drug usage period and the subsequent drug usage period are the same.

20. A method of visually presenting future drug use resulting from altered usage in a subject comprising:
selecting at least one drug associated with a predetermined digital patient information;
identifying at least one start time for administering a dosage of the at least one drug;
determining a future drug usage period from the digital patient information and the at least one start time;
determining a risk period from the digital patient information and the at least one start time, said risk period being associated with the at least one future drug usage period

21. The method of claim 20 wherein them method further comprises:
visually presenting the risk period associated with at least one future drug use period on a computer display.

22. The method of claim 20 wherein the digital patient information further comprises educational information about the at least one drug.

23. The method of claim 22 wherein the educational information includes information about at least one risk associated with the at least one drug.

24. The method of claim 23 wherein the at least one risk includes:
at least one contra-indicated drug;
at least one side-effect; or
at least one risk related to at least one physical condition of the subject.

25. The method of claim 23 wherein the at least one risk is associated with the risk period.

26. The method of claim 25 wherein:
the at least one drug is a contraceptive delivered to the subject in the form of a patch; and
the risk period is associated with a risk of pregnancy.

27. A system for visually presenting future drug use resulting from altered usage in a subject comprising:
a computer executable program;
a program memory for storing digital patient information;
the program, when executed by a processor, being structured to:
accept, via an input, data identifying at least one drug associated with the digital patient information;
accept, via the input, a first start time for at least one drug dosage;
determine an initial future drug usage period from the digital patient information and the first start time;
accept via the input data identifying at least one subsequent start time for at least one subsequent drug dosage; said subsequent start time being a function of altered drug use in a subject; and
determine a subsequent future drug usage period from the digital patient information and the at least one subsequent start time.

28. The system of claim 27 wherein the program, when executed by a processor, is further structured to:
transmit via an output to a display a visual presentation of the initial future drug usage period.

29. The system of claim 27 wherein the program, when executed by a processor, is further structured to:
transmit via an output to a display a visual presentation of the subsequent future drug usage period.

30. The system of claim 28 or 29 wherein the visual presentation of the periods are displayed in a calendar format.

31. The system of claim 26 wherein said calendar is a linear calendar.

32. The system of claim 27 wherein the program, when executed by a processor, is further structured to:
store drug state data for at least one subject's drug usage in a memory.

33. The system of claim 32 wherein the memory is in a secure environment.

34. The system of claim 32 wherein the memory is remotely located.

35. The system of claim 32 wherein the at least one subject's drug state data is accessible by at least one party.

36. The system of claim 32 where the at least one subject's drug state data is grouped by the subject's characteristics.

37. The system of claim 36 wherein the subjects' characteristics comprises a designation of a family relationship.

38. The system of claim 35 wherein the at least one party comprises at least one of:
a pharmaceutical company;
a health care professional;
a health management organization;
an insurance company;
a caretaker;
an party authorized to access the subject's drug state data; or
a family member of the subject.

39. The system of claim 35 wherein the at least one party offers recommendations based on the drug state data.

40. The system of claim 38 wherein;
the at least one party comprises a company offering pharmaceuticals; and
the company offering pharmaceuticals recommends purchases of pharmaceutical products.

41. The system of claim 27 wherein the digital patient information further comprises educational information about the at least one drug.

42. The system of claim 41 wherein the program, when executed by a processor, is further structured to:
transmit via the output to the display a visual presentation of the educational information from the digital patient information.

43. The system of claim 41 wherein the educational information includes instructions to aid in administering the at least one drug to the subject the method.

44. The system of claim 43 wherein the program, when executed by a processor, is further structured to:
accept via the input data identifying a specific issue to be addressed by visually presenting the instructions.

45. The system of claim 44 wherein the at least one drug is a contraceptive delivered to a subject in the form of a patch and the specific issue to be addressed includes:
the patch being off or partially off the subject for a predetermined time period, said patch having been previously applied to the subject;
not changing the patch within the predetermined time period;
not administering a first patch on a required start time;
not removing the patch from the subject at a predetermined time period, said patch having been previously applied to the subject; or
correctly applying the patch to the skin of the subject.

46. The system of claim 27 wherein the program is structured to be executed by a processor in at least one of:
a personal computer;
a personal digital assistant;
a cell phone;
a kiosk;
a digital watch; or
a drug dispensing device.

47. The system of claim 42 wherein the visual presentation is in the form of a multi-media presentation.

48. The system of claim 47 wherein the a multi-media presentation includes at least one of:
a video presentation;
pop-up windows;
an audio presentation;
at least one animated graphic; or
hyperlinks to the “internet”.

49. The system of claim 27 wherein the program is stored on computer executable media.

50. The system of claim 49 wherein the computer executable media comprises:
at least one compact disc;
at least one memory card; or
at least one diskette.

51. The system of claim 27 wherein the program is transmitted via the internet.

52. The system of claim 27 wherein the at least one drug for the initial future drug use period and the subsequent drug use period is different.

53. The system of claim 27 wherein the drug for the initial future drug use period and the subsequent future drug use period is the same.

54. A system for visually presenting future drug use resulting from altered usage in a subject comprising:
a computer executable program;
a program memory for storing digital patient information;
the program, when executed by a processor, being structured to:
accept, via an input, data identifying the at least one drug associated with the digital patient information;
accept, via the input, at least one start time for at least one drug dosage;
determine at least one future drug usage period from the digital patient information and the at least one first start time; and
determine a risk period from the digital patient information and at least one start time, said risk period being associated with the at least one future drug usage period.

55. The system of claim 54 wherein the program, when executed by a processor, is further structured to:
transmit via the output to the display a visual presentation of the risk period associated with the at least one future drug use period.

56. The system of claim 54 wherein the digital patient information further comprises educational information about the at least one drug.

57. The system of claim 56 wherein the educational information includes information about at least one risk associated with the at least one drug.

58. The system of claim 57 wherein the at least one risk is associated with the risk period.

59. The system of claim 58 wherein the at least one risk includes:
at least one contra-indicated drug;
at least one side-effect; or
at least one risk related to a physical condition of the subject.

60. The system of claim 58 wherein:
the at least one drug is a contraceptive delivered to the subject in the form of a patch; and
the risk period is associated with a risk of pregnancy.
